(19) United States
(12) Patent Application Publication
(10) Pub. No.: US 2001/0045492 A1
(43) Pub. Date: Nov. 29, 2001

(54) TRIPLE HYBRID WATER CRAFT

(76) Inventor: DON LEWIS, NEW YORK, NY (US)

Correspondence Address: ERIC P SCHELLIN, 2121 CRYSTAL DRIVE, SUITE 704, ARLINGTON, VA, 22202

(21) Appl. No.: 09/422,185

(22) Filed: Oct. 22, 1999

(51) Int. Cl. B64C 1/00; B64C 3/00; B64C 5/00; B64C 7/00

(52) U.S. Cl. 244/13

(57) ABSTRACT

A ground effect vehicle having a jet propulsion means as well as a propeller means. The ground effect vehicle is a watercraft combining the physical and hydrodynamic features of a trimaran, water jet propelled boat and air cushion vehicle that might be considered a hybrid. The vehicle is intended to operate as a multi-modal vehicle in the approximate speed range of 0-100 knots. The vehicle from at rest to operational speed obtains its lift at first from 100% buoyancy of trimaran hulls with jet propulsion, then from powered aerostatic lift from a captured air cushion achieved by means of forward movement achieved by an airplane type motor and propeller.

### BACKGROUND OF THE INVENTION

1. Field of the Invention

The invention relates to water borne craft, and, in particular to craft that are able to move horizontally in water prior to achieving a speed which permits them to move at low altitudes above the water employing ground effect principles.

2. Background Information

Conventional boats, long the choice for travel across expanses of water, have a number of disadvantages when used as modes of transportation. Since conventional boats are constantly displacing water they are limited in speed due to hydrodynamic drag. Hydrodynamic drag slows conventional boats due to both friction and the surface tension which makes the water adhere to the boat. Due to this drag, conventional boats require powerful motors to achieve high speeds and are fuel inefficient. In addition, the ride in a conventional high power boat is rough due to the fact that the boat will hit every wave crest.

Another choice for travel is a light plane. However, planes are expensive due to high insurance, regulation and licensing costs.

For more than sixty years, the principles of “ground effect” have been known and have been used with mixed success to provide craft that can fly at very low altitudes over water and land, thus providing a method of avoiding the disadvantages of conventional boats and light planes. Craft that cruise on the cushion of air provided by the pressure between the wings and water take advantage of “ground effect”. Craft that utilize the principles of “ground effect” avoid contact with the water at cruising speed, thus avoiding the disadvantages associated with hydrodynamic drag, and operate much more smoothly and efficiently than conventional boats.

“Ground effect” can be best defined through an analysis of Bernoulli's Principle. Bernoulli's Principle observes that as air gains speed, it loses pressure; as it loses speed, it gains pressure. Kinetic energy and pressure are mutually interchangeable forms of energy in a fluid such as air.

Normally air moves in straight lines. As air moves past an object, the normal straight-line flow is deflected into longer paths around the object. The long path forces the flow to speed up, thereby momentarily losing pressure. If an object is asymmetrical, the flow path along the longer side will cause the air to speed up and thus momentarily have a loss of pressure. Wings are an example of asymmetrical objects and are designed so that the loss of pressure on the top of the wing is greater than underneath the wing in order to induce lift. Symmetrical wings also work well in ground effect as long as they are at an angle to the ground.

The highest positive pressure that can act on a wing is stagnation or ram pressure. This occurs when flowing air is brought to rest or stagnated. When this occurs all of the kinetic energy of the air is transformed into pressure. During conventional air flight of air planes at normal cruising altitudes, this pressure appears only in a narrow region of the under surface of the wing, near the leading edge.

Vehicles which utilize the ground effect principle have designs which attempt to spread this light pressure or ram pressure area throughout the entire underside of the vehicle. One known design of a wing for ground effect vehicles includes the placing of the trailing edge of the wing as close to the water surface as possible. By this design the entire space under the wing is rammed full of slow moving air whose pressure is now close to the stagnation value. Ground effect vehicles attempt to maximize slow moving or stagnate air under the wing's surface, thereby increasing the efficiency of the vehicle in ground effect flight. The prior art teaches that the ideal design would seal the trailing edge of a ground effect craft's wing perfectly against the water in order to achieve full stagnation pressure under the wing, thereby creating the greatest amount of lift for the craft and be the most efficient. This has generally found to be impractical, however, due to the fact that no surface is completely flat and there must be wave clearance. This clearance is necessary in order to avoid damage to the wing or the craft.

One disadvantage that is inherent in most designs for ground effect vehicles which try to achieve the “perfect seal” is that the designs call for the trailing edge of the wing to be the lowest point on the craft. This means that the trailing edge is the last surface of the craft to leave the water and the surface upon which the craft lands. The trailing edge of the wing therefore bears much, if not most, of the brunt of takeoffs and landings. In order to strengthen the trailing edge, some designers have added weight to that portion of the wing. This added weight, however, changes the center of gravity of the craft.

Despite the impracticality of achieving the “perfect seal”, ground effet travel is highly efficient because hydrodynamic drag is greatly reduced, if not eliminated, once the ground effect craft leaves the water and reaches cruising speed and altitude.

Other sources of drag, including skin friction and wake drag, remain. In addition, the higher-pressure air in the flow underneath the wing spreads outward, towards the wing tips. The low pressure flow on the top of the wing is pushed inward by the atmospheric pressure, towards the fuselage. At the tip of each wing, the higher pressure air from underneath the wing spills off and curls upward into the lower pressure zone above the wing and wraps around it to form a wing tip vortex. Power is necessarily consumed in generating these vortices and the result is called induced drag.

The velocity field of the wing tip vortices creates a downwash, thereby slanting the entire airflow downward slightly. Lift acts perpendicular to the air flow, so this downwash tilts the lift vector back slightly. The tilted vector is composed of a vertical component (true lift) and a smaller horizonal component (induced drag).

During ground effect travel there is no place for the downwash to go, so the lift vector returns to near vertical; and, its horizontal component (induced drag) becomes very small. The reduction in induced drag is one of the most desirable features of travel according to ground effect principles, because it greatly reduces the power that is required for moving the craft.

In conventional air flight, peak pressure on the wing's under surface is located near the leading edge. In ground effect, however, the high pressure spreads to cover most of the under surface. The center of lift moves rearward thereby causing the wing to pitch down as it settles into ground effect and to pitch upward as it rises out from ground effect. Stable ground effect travel would be difficult if the craft nosed over as it approached the surface, which is what will happen with typical wing platforms.

In the prior art, one way to make the wing pitch stable was to sweep the tips forward, thereby creating a reverse-delta platform. In free flight, lift decreases towards the wing tips, because the high pressure from beneath the wing spills off the tips. In ground effect, this spillage is greatly reduced by the closeness to the surface, so the wing gains lift fastest at the tips. As a reverse delta wing settles into ground effect travel, its tips lift faster than the remaining portion of the wing. Because the wings are swept far forward, the lift near the tips helps to counter the natural pitch down tendency.

There are a number of patents which deal generally with the use of ground effect to attempt to provide more efficient travel over water. Such patents include, for example, U.S. Pat. Nos. 3,190,582, 3,627,235, 3,661,111, 3,830,179 and 3,830,448 all to Lippisch.

Additionally, U.S. Pat. No. 5,697,468 to Russell, Jr. discloses a ground effect vehicle constituting a basis over which the present invention is an unobvious improvement, which is incorporated herein in its entirety.

Pat. No. 3,968,762 to Meyer Jr. combines the features of a ground effect catamaran hulled watercraft with retractable hydro foils and conventional subcavitating propeller driven means or a waterjet system. The patent to Meyers Jr. is incorporated herein in its entirety.

Traditionally, the prior art craft are single mode, that is, they rely for lift or buoyancy on a hull, which can take the form of a single hull, catamaran or trimaran. They may be on an air cushion, often depending on the speed range in which they primarily operate. The hull style is used when the craft is at rest or when it is beginning or ending a run. The air cushion style by itself has unusual power requirement until it rides on its cushion of air. Each mode, then, is limited in speed and power requirements.

### SUMMARY OF THE INVENTION

Briefly the instant invention overcomes the disadvantges of the prior art by providing a triple modal hybrid wherein the craft obtains its lift from the buoyancy of its trimaran hulls, or from the powered aerostatic lift from a captured air cushion, and a combination thereof. One of the major advantages achieved by the multi-modal feature is the relatively favorable lift-to-drag ratios (L/D) of each lift-producing mode over the different portions of the speed spectrum from “at rest” to “maximum speed”. The buoyant bodies (trimaran) produce relatively high L/D in the low end of the speed spectrum, and the lower length-to-beam ratio powered aerostatic lift system produces relatively high L/D in the high end of the speed spectrum. Hence over the entire speed range there are two transition speeds, which can be selected to minimize drag. Depending on the particular sea condition encountered, any one, or combination of modes can be selected, each of which has a different operational waterline.

The propulsion system includes a water jet system for the buoyant mode and for air cushion mode an airplane type propeller engine is employed mounted on top of the fuselage. The system may be of the conventional pusher type to diminish cabin noise.

### BRIEF DESCRIPTION OF THE DRAWINGS

A more complete understanding of the invention and many of the attendant advantages thereto will be readily appreciated as the same become better understood by reference to the following detailed description when considered in connection with the accompanying drawings, wherein;

FIG. 1 represents a side view of the triple hybrid vehicle of the present invention;

FIG. 2 is a top plan view of the embodiment of the vehicle depicted in FIG. 1;

FIG. 3 is a front view of the said vehicle showing the positioning of the vehicle in the water at near the beginning of the run;

FIG. 4 is a rear view of the said vehicle showing the vehicle in the same position as in FIG. 3.

### DETAILED DESCRIPTION

While the invention will be described in connection with a preferred embodiment, it will be understood that it is not intended to limit the invention to the described embodiment. On the contrary, it is intended to cover all alternatives, modifications and equivalents as may be included within the spirit and scope of the invention as defined by the appended claims.

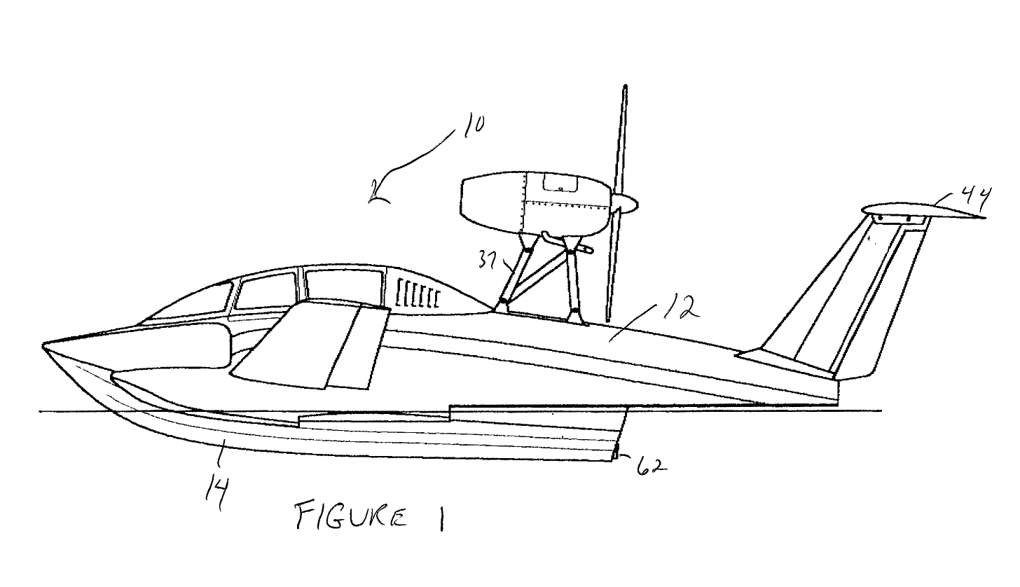

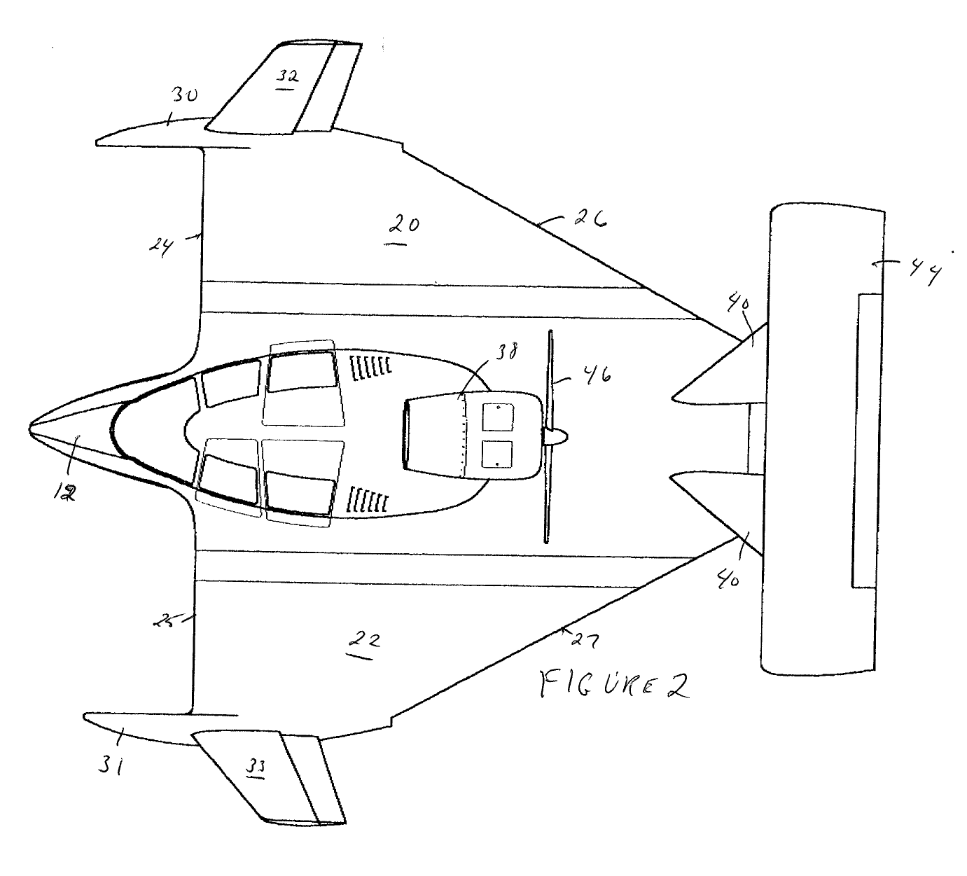

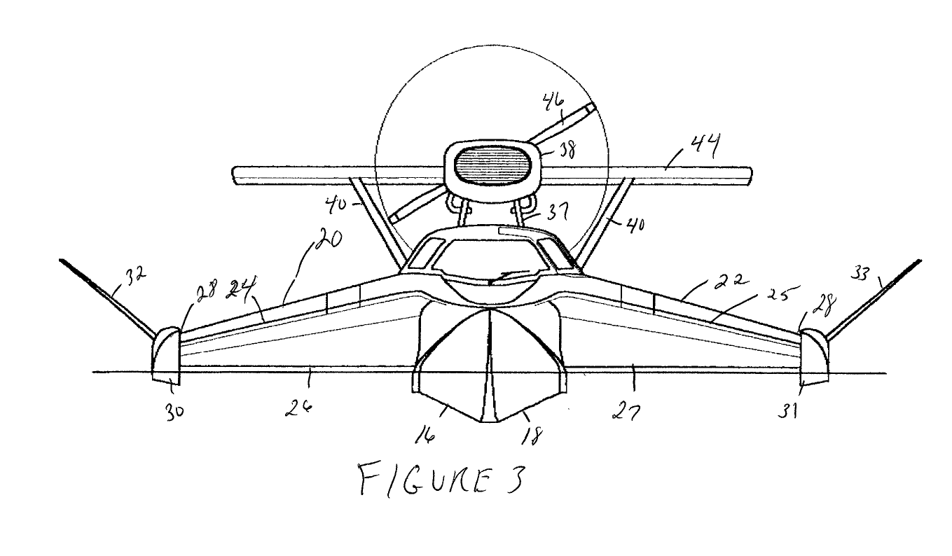

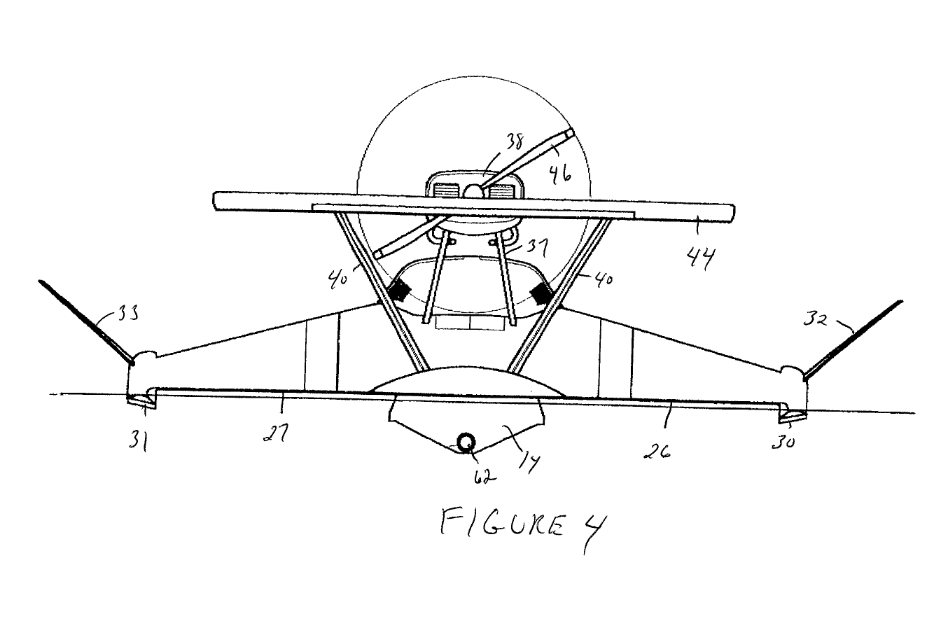

Turning to the FIGS. 1-4 the vehicle 10 has a fuselage 12 within which there is a cabin and cockpit for passengers and a pilot. Adequate room may be provided in the fuselage for storage of various types of cargo. At the bottom of the fuselage 12 is a hull 14 which in the preferred embodiment of the invention is the lowest point on the vehicle and is the surface from which the vehicle takes off and lands.

One preferred design of the hull 14 includes a number of surfaces 16 and 18 to make the hull 14 travel more efficiently through the water. Wings 20 and 22 are provided at the side of the fuselage 12. In most applications, a conventional reverse delta ground effect wing is used. The wing span of the vehicle can be any length, but in the preferred embodiment, the wingspan is approximately 7.9 meters. In the preferred embodiment the wings 20 and 22 are each provided with a leading edge 24 and 25 and trailing edges 26 and 27.

While prior art designs have required that the trailing edges 26 and 27 be the lowest point on the craft and prior designers have believed that the closer the trailing edge is to the surface to be traveled, whether water or land, the better lift is achieved, the inventor of the present invention has surprisingly discovered that there is constant lift up to approximately five inches off the surface. This discovery has allowed the design of the craft 10 of the present invention to place the trailing edges 26 and 27 off the water and higher up on the hull 14 than other conventional ground effect vehicles. This is illustrated by the positioning of the trailing edges 26 and 27 above the hull 14 at a point where the trailing edges 26 and 27 are above the surface to be travelled at a distance of up to five percent of the wing span of the craft. In the preferred embodiment which has a wingspan of approximately 7.9 meters, it is preferred that the trailing edges 26 and 27 of the wings are approximately six inches above the water. This placement of the trailing edges 26 and 27 allows the hull 14 to absorb the brunt of the impact of take offs and landings while still allowing for the lift due to ground effect.

At the outer edge 28 of each wing 20 and 22, downwardly extending pontoons or floats 30 and 31 may be positioned, along with upwardly extending winglets 32 and 33. Along a rear surface of the winglets rudders may be provided. The result is a trimaran.

Extending upwardly from the rear of the hull 14, twin tails 40 are provided. A horizontal stabilizer 44 is mounted on top of the twin tails.

One preferred embodiment of the craft of the present invention includes a propeller engine combination for powering the craft. On the top of the fuselage 12, a housing 38 is provided. Within the housing 38, a motor is positioned to which a multi-bladed propeller 46 is attached. The housing 38 is mounted on top of a stanchion 37 which is mounted on the fuselage 12.

Additionally, when the vehicle is in the water it can be driven forward by water jet means power for which is supplied by a motor in the hull which scoops up water and thrusts it back towards the rear all in a conventional manner through jet orifice 62.

Forward extending left and right conventional bow thrust propulsion means may be supplied to achieve docking as needed.

In operation, the jet drive and the air engine propel the craft forward. At a speed of about 45 mph the wings start to lift the craft and it takes off at approximately 55 mph. Upon reaching an approximate speed of 55 mph the watercraft will lift off from the water. Upon being airborne, the water jet propulsion system is shut off, for it is at this point a ground effect vehicle.

The system operates most efficiently at about eight feet above the water. Top speed is about 115 mph but normal operation will be about 90 to 100 mph.

It is also considered to be understood that the embodiments of the invention other than the one described or modifications of the one described are possible within the scope of the subject invention which is limited only by the attached claims:

What is claimed is:

1. A multi-modal watercraft having a wide speed range with favorable lift-to-drag ratio resulting in good performance under various ratios resulting in good performance under various sea conditions comprising:
a fuselage, said fuselage having a top side;
a hull disposed below the fuselage, the hull having a left and right side;
a pair of opposite side wings attached to the fuselage, each wing having a top surface, a bottom surface and an outer edge;
each of said wings terminate in a float at the side of the wing opposite to the side where it is attached to the fuselage;
said hull being fitted with a waterjet propulsion system whereby said watercraft is propelled forwardly when said hull is in the water;
a vehicle propulsion means attached to the top side of the fuselage or air propulsion of the watercraft in ground effect flight.

2. The multi-modal watercraft of claim 1 wherein the vehicle propulsion means attached to the top side of the fuselage has an air propeller mounted to push the watercraft.

3. The multi-modal watercraft of claim 1 wherein the fuselage terminates in a tail stabilizer positioned in a horizontal plane above the fuselage.

4. The multi-modal watercraft of claim 1 wherein the pair of opposite side wings attached to the fuselage describe a reverse delta configuration.

5. The multi-modal watercraft of claim 4 wherein the opposite side wings each has a leading edge and each has a trailing edge, said trailing edge being lower along a horizontal plane than said leading edge adapted and constructed to capture a cushion of air when said watercraft is propelled forward.
